(19) United States
(12) Patent Application Publication
(10) Pub. No.: US 2012/0097691 A1
(43) Pub. Date: Apr. 26, 2012

(54) Arrangeable husbandry system and method

(76) Inventor: Lesli Ott, New Haven, CT (US)

(21) Appl. No.: 12/925,404

(22) Filed: Oct. 20, 2010

(51) Int. Cl. B65D 25/00; B23P 19/00

(52) U.S. Cl. 220/737; 29/428

(57) ABSTRACT

Arrangeable systems and methods that provide capabilities of utilizing a single husbandry container in multiple dispositions. The systems and methods are practiced in varying combinations by differing embodiments, with many of the embodiments' husbandry containers, for example, being well suited for both alterable suspension on a repositionable member as well as stable placement as tableware. Among the parts utilized in many of embodiments are base, arrangeable member, and container portions.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present application relates to dispositions of a husbandry suitable enclosure and, more specifically, to providing multiply arrangeable systems and methods of dispositioning a husbandry suitable enclosure, most commonly within an interior space.

2. Related Art

Interior living space circumstances can often restrict their occupants' wishes. One relatively frequent desire is an interest in maintaining living organisms, such as plants, within the living space to enhance the occupants' experiences. This maintaining generally involves concomitant requirements, such as appropriate lighting for most plants and/or suitable ambient temperatures for both plants and animals. Additionally, the majority of living spaces' circumstances constrain the options available for achieving at least some of these maintaining requirements. Moreover, many occupants prefer flexibility in their options to accommodate both differing circumstances (such as temporal changes in the amount and direction of available sunlight) as well as differing intentions (such as desiring to disposition a plant for decorative effect in the evening without hindering the ability to best disposition the plant to receive sunlight during the day.) A substantial variety of approaches have been developed to address these issues, usually with an emphasis on one or the other particular need. Assorted approaches have attempted to address more than one need, or provide options for flexibility in disposition, but these attempts have been primarily suited to, at best, address one objective well and have largely left the other objectives to be inadequately, if at all, addressed. The thinking behind these strategies regularly appears to indicate that the other objectives are considered ancillary bonuses which do not require the same degree of accomplishment.

Included among the diverse effects desirable of a husbandry suitable enclosure are:
a) Providing indoor plants with adequate sunlight. In one common maneuver, a planter is rested on or affixed to a windowsill. However, this placement can impair the functioning of a window or partially block a view, and risks toppling the planter during window operation. Additionally, windowsill placement subjects plants to potentially damaging significant temperature variations, due to the greater volatility of the ambient environment in the immediate vicinity of a window. Avoiding these complications while still gaining the requisite sunlight would be preferable.
b) Providing specific light distributions to enable particular plant health and appearance objectives. Rotating plants over time (generally days or weeks) is one manner of shaping the light distribution received by a plant. However, larger planters (such as windowsill planter boxes) can be difficult or awkward to easily rotate, and foliage spread is generally limited by spatial factors such as the window surface's proximity to the windowsill edge. Greater dispositional flexibility, including readily arrangeable options, would be preferable.
c) Enabling flexibility of husbandry suitable enclosure dispositioning, to accommodate for ordinary restrictions on space available for structural supports in crowded living spaces;
d) Avoiding adverse impacts on the health of the enclosed organism(s), such as due to tampering by pets or small children, as well as adverse impacts on the welfare and cleanliness of the living space and its occupants, such as when pets may strew dirt upon a carpet or small children may ingest toxic vegetation.
e) Enabling the husbandry suitable enclosure to be readily adaptable for displaying esthetic imagery, as well as being accessible as a separate entity, both for decorative and functional (such as soil renewal) purposes, particularly without difficulty in placing the husbandry suitable enclosure upon any available suitable surface.

### SUMMARY OF THE INVENTION

The present invention includes systems and methods for providing at least some of the above desirable effects, in addition to other benefits that will be apparent from the present description and claims. A first principal feature of many of the embodiments of the present invention is a base portion that frequently incorporates an anchoring affixment and at least a first junction suited for assembling a first coupling when combined with a first junction mate. An arrangeable member that is a second principal feature of many of the embodiments of the present invention frequently incorporates the first junction mate and usually further incorporates a spatially separated second junction. A third principal feature of many of the embodiments of the present invention is a holder for husbandry suitable enclosures that can be readily arranged in a multitude of dispositions, as well as in a plurality of configurations, including at least one wherein the holder is available for separate disposition by detachment from the remainder of the present invention embodiment. The holder can be integrated within a husbandry suitable enclosure or can be adapted for receiving and holding a separate enclosure to provide additional usage flexibility. The holder also concurrently incorporates a second junction mate that can combine with the second junction to assemble a second coupling. Either, or both, of the first and second couplings can be multiply dispositionable, such as by enabling relative rotation between the junction and its mate that form the coupling. The couplings can be constructed to enable restricted degrees of relative motion, and/or can provide manners of selectively arresting the relative positions of its constituent junction and junction mate, and/or can be alternately adapted for ready disassembling or for securing the combination of the junction and its mate against disassembling.

A multitude of benefits are providable by at least some embodiments of the present invention. Included among these benefits are the capability of readily arranging the husbandry suitable enclosure's disposition both towards and away from a window, in order to tailor the husbandry suitable enclosure's disposition to accommodate variations in sunlight and/or temperature. Ready rearranging also allows the window to be used for other purposes more easily. The flexibility of disposition also facilitates tailoring the light distribution received by the enclosure. Variations in the manner of construction of the base portion enables options for mounting the planter on vertical as well as horizontal surfaces. The enclosure can be further configured to receive and display various imagery when preferred to further augment decorative options.

Other objects and features will be in part apparent and in part pointed out hereinafter.

### BRIEF DESCRIPTION OF THE DRAWINGS

FIG. 1 depicts a partially exploded perspective view of a first embodiment of the present invention.

FIG. 2 depicts a side view of a base that incorporates a multiply-differently-sized first-junction-mate-accommodating alternate first junction.

FIG. 3 depicts a side view of a base that incorporates a horizontally-oriented structural surface anchoring affixment.

FIG. 4 depicts a perspective view of a husbandry suitable enclosure incorporating a pair of first display slots.

FIG. 5 depicts a side, partially exploded, partial cross-section view of a relative motion facilitating assemblable first coupling.

FIG. 6 depicts an enclosure holder constituent of a number of embodiments of the present invention.

FIG. 7 depicts a front, partial cross-section view of a base that incorporates a first relative-motion-constraining first junction constituent of a number of embodiments of the present invention.

FIG. 8 depicts a side, partial cross-section view of a base that incorporates the relative-motion-constraining first junction constituent (also depicted in FIG. 7.)

FIG. 9 depicts an attachment-plate-plane view of a multiple-first-junction incorporable base constituent of a number of embodiments of the present invention.

FIG. 10 depicts a side view of the multiple-first-junction incorporable base constituent (also depicted in FIG. 9.)

FIG. 11 depicts a partial see-through view of a first extent alterable first arm variant.

FIG. 12 depicts a partial see-through view of a fixable-against-release second coupling variant.

FIG. 13 depicts a partially exploded view of an articulation incorporating first arm variant.

FIG. 14 depicts an exploded, partial cross-section, detail view of a base that incorporates a second relative-motion-constraining first coupling.

FIG. 15 depicts an axial view of a second relative-motion-constraining first junction.

### DETAILED DESCRIPTION OF THE PREFERRED EMBODIMENTS

In the following description, identical numbers indicate identical elements. Where an element has been described in one Figure, and is unaltered in detail or relation in any other Figure, said element description applies to all Figures.

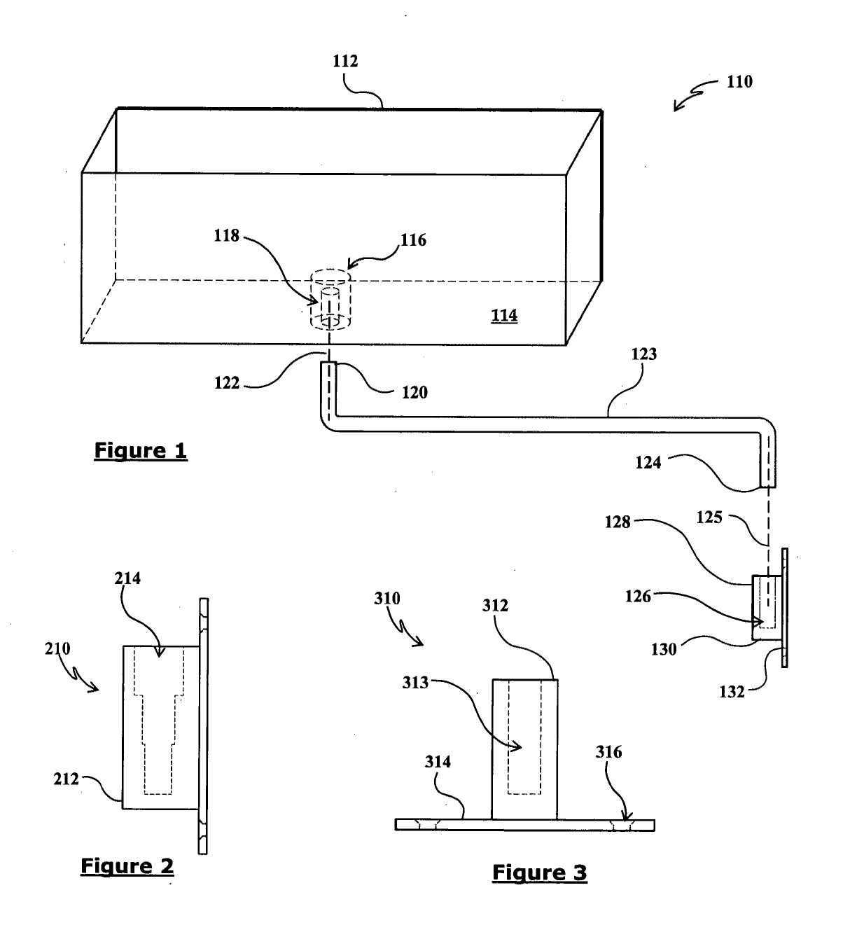

As shown in FIG. 1, a first embodiment 110 includes a terrarium 112 serving as an enclosure holder, including an undersurface 114 of the terrarium 112 providing a surface for resting the terrarium 112 upon a structure without affect from a second receiver 116 that serves as a second junction mate. (It should be understood that the present invention encompasses alternate enclosures than terrariums, including aquariums, as well as essentially any other similar enclosure, or even a general undifferentiated container.) The second receiver 116 includes a second cavity 118 in which an arm second end 120 that serves as a second junction is insertable by translation along the axis 122 to form one version of a second coupling, which is rotatable about the axis 122. An arm 123 serves as an arrangeable member and includes an arm first end 124 that serves as a first junction mate and is insertable by translation along the axis 125 into a first cavity 126 formed within a first receiver 128 that serves as a first junction. When the arm first end 124 is inserted into the first cavity 126, they form the first coupling which is also rotatable about axis 125. In addition to the first receiver 128, a first receiver assembly 130 that serves as a base, further includes a securing plate 132 that serves as an anchoring affixment.

As shown in FIG. 2, a second receiver assembly 210, that can also serve as a base, includes a first alternate receiver 212 that includes a stepped cavity 214 that can also serve as a first junction. The stepped cavity 214 provides capabilities of utilizing differing sized arms 123 to provide additional utilization flexibility (such as, for example, when a particular décor preference is impaired by a larger arm 123.)

As shown in FIG. 3, a third receiver assembly 310, that can also serve as a base, includes a second alternate receiver 312 that includes the first cavity 313 that can also serve as a first junction. The third receiver assembly 310 is constructed to facilitate serving as a base affixed to a horizontal surface (as opposed to the first and second receiver assemblies 130 and 210, respectively, that are suited for serving as a base affixed to vertical surfaces,) since its securing plate 314 is dispositioned at a right angle to the direction in which the arm 123 is inserted into the cavity 313. A screw hole 316 is a standard means of affixing the third receiver assembly 310 to a structure, but is not limiting of the variety of means in which this securing can be effected, as is well known to those of skill in the art.

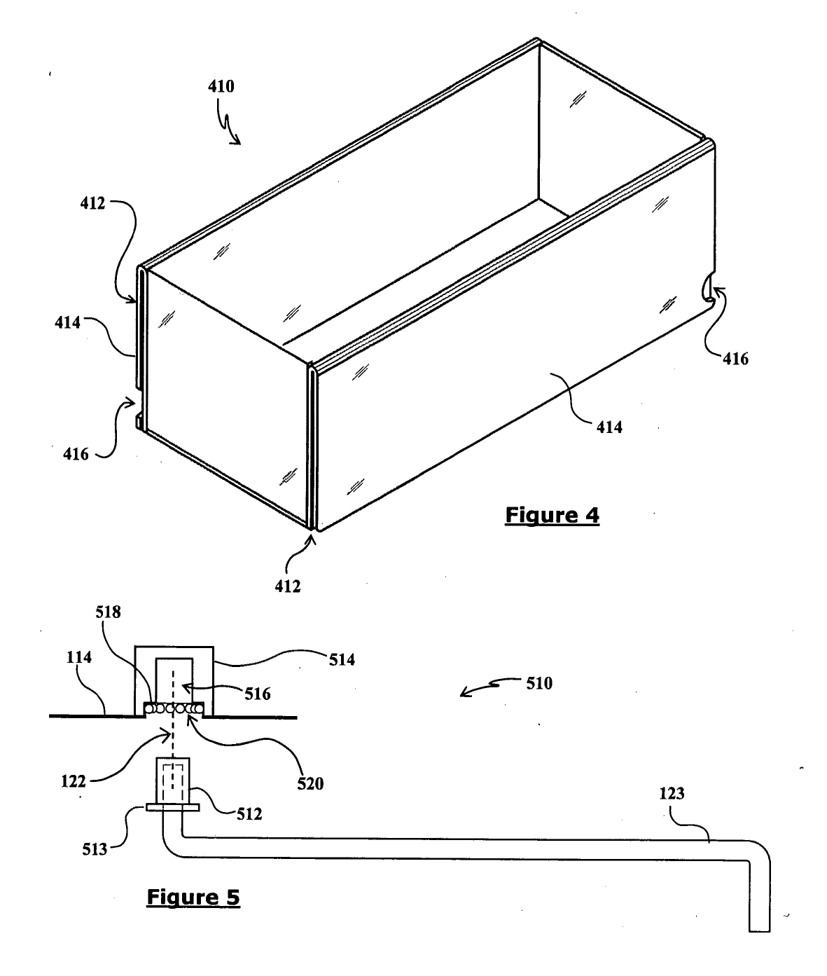

As shown in FIG. 4, a first alternate terrarium 410 is constructed to provide additional decorating options, by virtue of its inclusion of display slots 412 formed by folded over terrarium sides 414. The display slots 412 as shown are suited for receiving primarily planar imagery, although forms other than planar are also within the scope of the present invention as can be readily envisioned by one of skill in the art. The imagery can be positioned within the display slots 412 by use of the cutouts 416.

As shown in FIG. 5, a first alternate second junction 510 includes an arm second end cap 512 constructed with a cap shoulder 513. The cap 512 is received by a first alternate second receiver 514 integrated within the lower portion of an enclosure holder. A second cavity 516 includes a shoulder mate 518 that retains a plurality of bearings 520 to facilitate rotational motion of the husbandry suitable enclosure relative to the cap 512. When the cap 512 serves as a second junction to form an alternate second coupling by mating with the first alternate second receiver 514 serving as a second junction mate, the bearings can ease alteration of the disposition of the husbandry suitable enclosure.

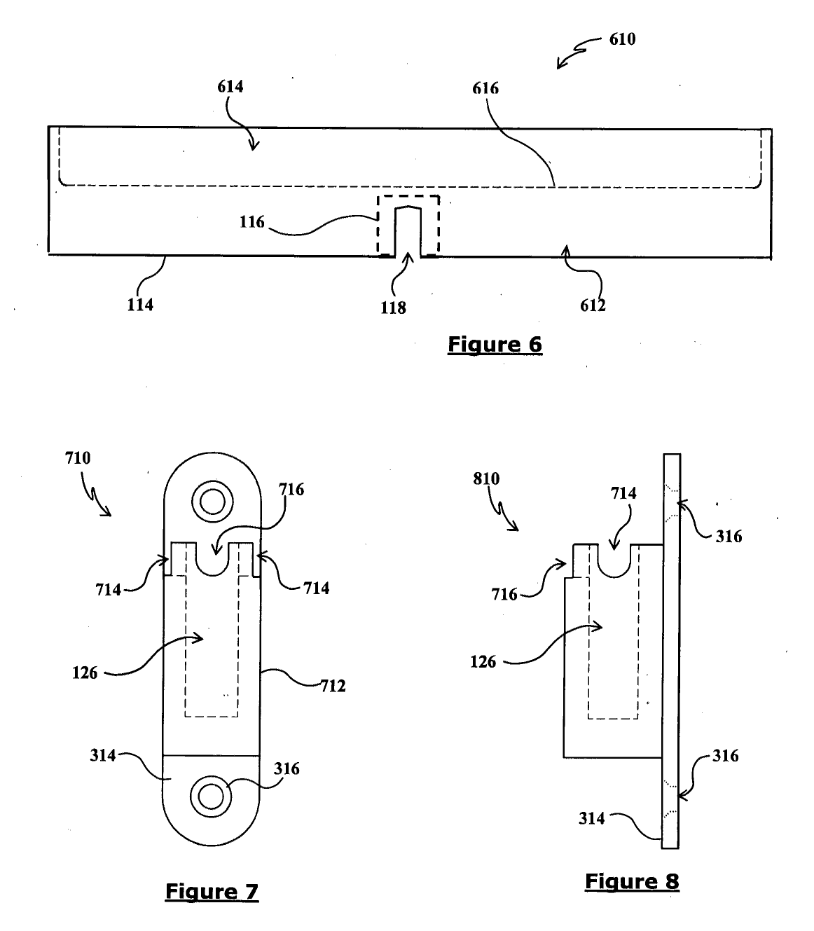

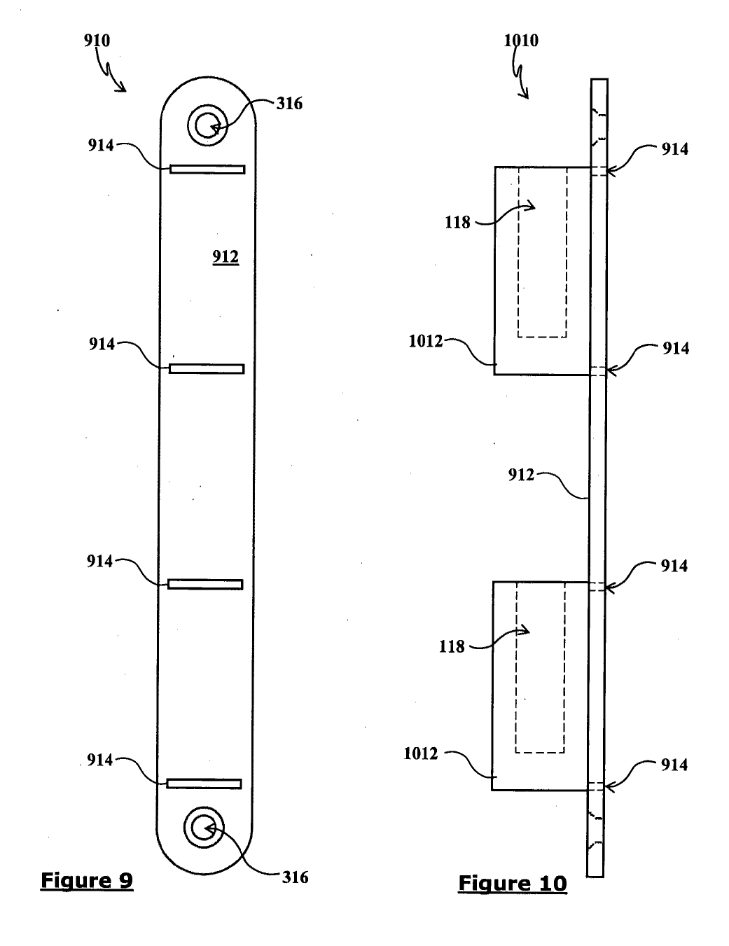

As shown in FIG. 6, an alternate enclosure holder 610 includes a platform 612 which affords space to disposition the second receiver 116 and second cavity 118, as well as maintain the undersurface 114. Formed into the platform 612 is a void 614 with a bottom 616 adapted for impermanent disposition of an enclosure such as a terrarium or the like. It should be understood that in various embodiments of the present invention the enclosure holder may be integrated within the enclosure itself, while in others it will be separable. Furthermore, the particular forms of the alternate enclosure holder 610, the void 614, as well as the enclosure they are suited to hold are merely illustrative examples and the scope of embodiments of the present invention encompass essentially any form of shape or interconnection between the enclosure holder and its corresponding enclosure, manners of modification of which being readily understood by those of skill in the art, and the particular examples depicted are not intended to be limiting.

As shown in FIGS. 7 & 8, a front view 710 and a side view 810 of a fourth receiver assembly 712 includes a fourth receiver 712 with side cutouts 714 and a central cutout 716 into which the arm 123 can settle, its motion arrested by the relative fit of the cutouts 714 and 716 and the arm 123. The exact forms, number, and disposition of the cutouts 714 and 716 are merely illustrative examples, and should not be considered limiting. As is readily understood by one of skill in the art, these can be widely varied without deviating from the inventive essence.

As shown in FIGS. 9 & 10, a front view 910 and a side view 1010 of a fifth receiver assembly can serve as a multiply configurable first junction, wherein the positioning, and number, of fifth receivers 1012 that include the second cavity 118 are alterable. A multi-receiver securing plate 912 includes a plurality of slots 914 positioned so as to provide flexibility of dispositioning of one or more fifth receivers 1012 which include projections or other forms of complementary elements that can sustain the fifth receivers 1012 when appropriately positioned in alliance with a pair of the slots 914. In the side view 1010, a pair of fifth receivers are depicted in one representative, though not limiting, arrangement. The exact forms, number, and disposition of the slots 914 and fifth receivers 1012 are merely illustrative examples, and should not be considered limiting. As is readily understood by one of skill in the art, these can be widely varied without deviating from the inventive essence.

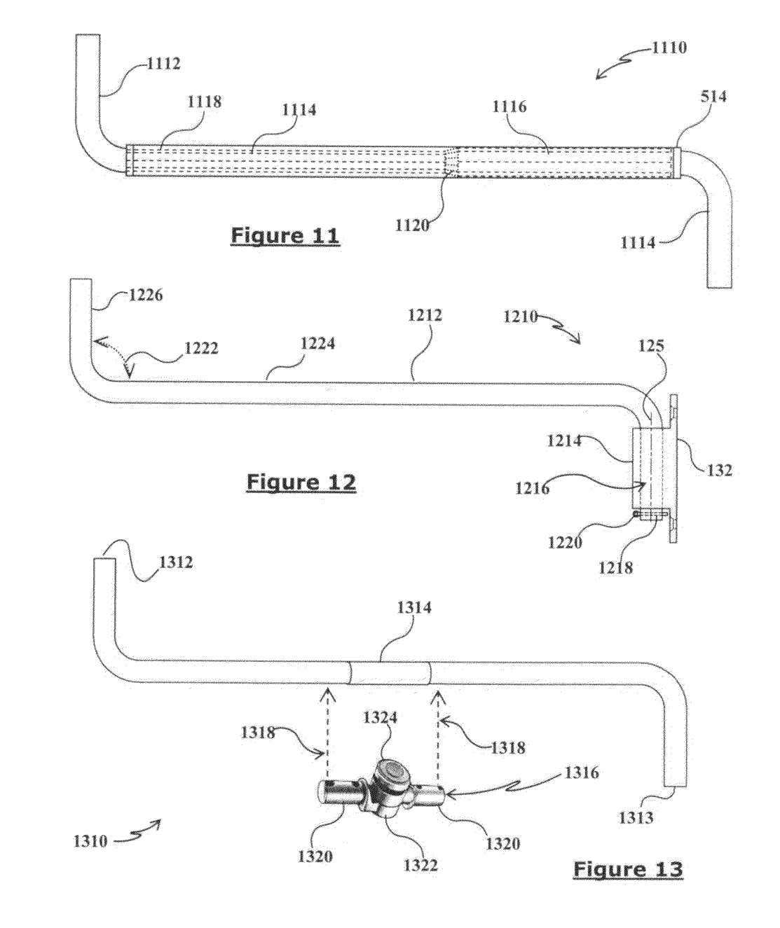

As shown in FIG. 11, an extending arm 1110 includes an inserted section 1112 that slides within a sleeve section 1114. The inserted section 1112 includes narrower and wider sectors 1114 and 1116, respectively, with the narrower sector 1112 moving freely through an end ring 1118 while the wider sector 1116 can not, so that the relative motion of the inserted section 1112 and the sleeve section 1114 are arrested when the transition zone 1120 reaches the end ring 1118. The exact characteristics of the construction of the inserted section 1112 and the sleeve section 1114 are merely illustrative examples, and should not be considered limiting. As is readily understood by one of skill in the art, these can be widely varied to effect an extendable arm without deviating from the inventive essence.

As shown in FIG. 12, a locking first coupling 1210 includes a locking arm 1212 which inserts in a sixth receiver assembly 1214 whose open cavity 1216 does not include a bottom, so that the lower end 1218 of the locking arm 1212 can reach therethrough to expose an opening in which a pin 1220 can be inserted to ensure that the locking arm 1212 does not separate from the sixth receiver assembly 1214. The exact characteristics of the construction of the locking of the locking arm 1212 is merely an illustrative example, and should not be considered limiting. A relative angle 1222 is defined by the horizontal portion 1224 and the vertical portion 1226, and can be varied for differing functions. In certain differing embodiments, the relative angle 1222 will vary. Though it will often be a simple right angle, as shown in many of the drawings, in other embodiments the relative angle 1222 may differ slightly or significantly (not shown) from 90 degrees. For example, in certain embodiments it may equal about 92 degrees, which will compensate for the probable moderate bending of the locking arm 1212 when the vertical portion 1226 is supporting a load such as the first alternate terrarium 410. The locking arm 1212, when supporting the load with the relative angle 1222 approximating 92 degrees, will appear to be essentially horizontal which may be preferred for esthetic or other reasons. As is readily understood by one of skill in the art, these can be widely varied to effect a lockable arm without deviating from the inventive essence.

As shown in FIG. 13, a hinging arm 1310 can include virtually any of the varieties of second junction 1312 and first junction mate 1313, and includes a central removable region 1314 that is replaceable by a commercially available standard inline pivoting hinge 1316 by displacement in the direction of arrows 1318. The pivoting hinge 1316 includes end portions 1320 that are affixed to the portions of the hinging arm 1310 on either side of central removable region 1314. The pivoting hinge 1316 is rotatable about the pivot 1322, and its pivoting action may be optionally also be arrestable by action of the stop button 1324. The exact characteristics of the construction of the hinging of the hinging arm 1310 is merely an illustrative example, and should not be considered limiting. As is readily understood by one of skill in the art, these can be widely varied to effect an articulating arm without deviating from the inventive essence.

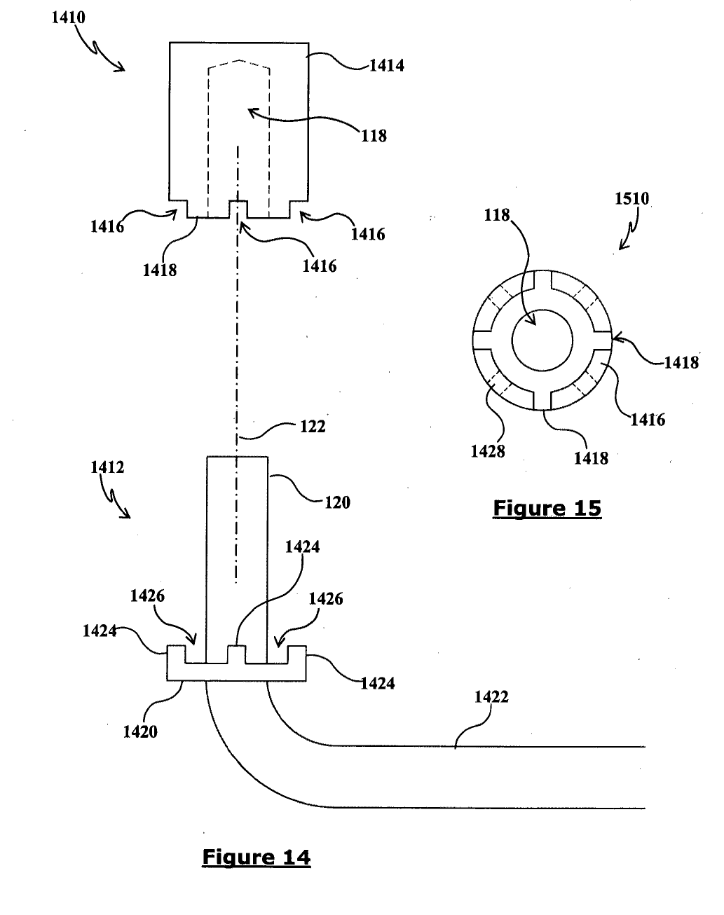

As shown in a side view in FIG. 14 and an under view 1510 in FIG. 15, a partially repositionable first coupling is assembled from a detent limited second junction mate 1410 (seen in the under view of FIG. 15) and a detent limited second junction 1412. The detent limited second junction mate 1410 includes a detent limited receiver housing 1414 that incorporates at least one detent catch 1416 and at least one detent catch spacer 1418. The detent limited second junction 1412 includes a detent ring 1420 dispositioned on the second junction end of the detent adapted arm 1422. The detent ring 1420 incorporates at least one detent 1424 and at least one detent spacer 1426. The detents 1424 and detent spacers 1426 mate cooperatively with the detent catches 1416 and detent catch spacers 1418 to provide, most often, a plurality of relatively rotated dispositions for the detent limited second junction mate 1410 and the detent limited second junction 1412. Also as seen in FIG. 15, alternative spacings 1428 for the detents and corresponding catches are also available. The exact characteristics of the construction of the partial repositioning of the partially repositionable first coupling is merely an illustrative example, and should not be considered limiting. As is readily understood by one of skill in the art, these can be widely varied to effect a repositioning first coupling without deviating from the inventive essence.

It is also important to comprehend that the particular dimensions, and arrangements of many of the components of the present invention are merely illustrative, and are not limiting of the variations that fall within the scope of the present invention. For example, the arms shown that serve as the arrangeable members can be widely varied, including differing vertical and/or horizontal dimensions, their relative sizes, the number of transitions between horizontal and vertical extents, as well as means to utilize arms as arrangeable members that include portions that are not only horizontal or only vertical. When an embodiment variation includes one or more arm portions that are not horizontal or vertical, combined with one or more other portions that are horizontal or vertical, the relative angles between these portions will not be an exact right angle, although it will often be close. Among the reasons to choose close to, but not exact, right angles is that a supporting extent of arm will commonly exhibit a degree of bending when providing a lifting force at in directions that are not parallel to the force of gravity. In such a case, a slight divergence from a right angle can, for example, compensate for this bending and provide the illusion of a straight horizontal support which may be esthetically preferable. In view of the above, it will be seen that the various objects and features of the invention are achieved and other advantageous results obtained. The examples contained herein are merely illustrative and are not intended in a limiting sense.

What is claimed is:

1. An arrangeable system for holding at least one husbandry suitable enclosure, comprising:
a base incorporating at least a first anchoring affixment and at least a first junction;
an arrangeable member incorporating at least a second junction, at least a first junction mate, and a first extent separating the first junction mate and the second junction;
an enclosure holder incorporating at least a second junction mate and an undersurface adapted for disposition upon a structure without affect by the second junction mate;
multiply dispositionable first and second couplings assemblable, each in turn, by combining the first and second junctions with the first and second junction mates, respectively;
wherein the enclosure holder is arrangeable in at least first and second/arrangements, said first/arrangement entailing the first and second couplings being assembled, and said second/arrangement entailing at least the second coupling being unassembled.

2. An arrangeable system for holding at least one husbandry suitable enclosure according to claim 1, wherein said enclosure holder is adapted for holding at least a first enclosure suitable for husbandry purposes, said holding comprising at least one of:
a) the enclosure holder and the husbandry suitable enclosure being mutually integrated, and
b) the enclosure holder and the husbandry suitable enclosure being readily detachable.

3. An arrangeable system for holding at least one husbandry suitable enclosure according to claim A2, wherein at least one of the enclosure holder and the husbandry suitable enclosure incorporates at least a first display slot adapted for exhibiting imagery and, optionally, said first display slot can exhibit imagery releasably such that a plurality of imagery is displayable.

4. An arrangeable system for holding at least one husbandry suitable enclosure according to claim 1, wherein the base anchoring affixment is affixable to a support in at least a first orientation, said first orientation including at least vertical and horizontal orientation alternatives.

5. An arrangeable system for holding at least one husbandry suitable enclosure according to claim 1, wherein at least one of said first and second couplings, when assembled, is releasable.

6. An arrangeable system for holding at least one husbandry suitable enclosure according to claim 5, wherein at least one of the releasable couplings is fixable against release from the assembled condition.

7. An arrangeable system for holding at least one husbandry suitable enclosure according to claim 1, wherein at least one of the first and second couplings facilitates relative motion, respectively, between the arrangeable member and the base or between the arrangeable member and the enclosure holder.

8. An arrangeable system for holding at least one husbandry suitable enclosure according to claim 1, wherein at least one of the first and second couplings allows relative motion between the junction and the junction mate that comprise that coupling and, optionally, at least one of the at least one relative motion allowing coupling can constrain said relative motion.

9. An arrangeable system for holding at least one husbandry suitable enclosure according to claim 1, wherein at least one of the first and second junctions and the first and second junction mates can assemble a coupling with a plurality of differing counterpart junctions or junction mates, said plurality of differing counterpart junctions or junction mates differing according to at least one of their size, orientation, disposition, and construction.

10. An arrangeable system for holding at least one husbandry suitable enclosure according to claim 1, wherein said base can incorporate at least one of a plurality of anchoring affixments and a plurality of first junctions and, optionally, at least one of the plurality of first junctions is detachable.

11. An arrangeable system for holding at least one husbandry suitable enclosure according to claim 1, wherein the arrangeable member can assume at least one of a plurality of configurations that include a first configuration incorporating a variable first extent and a second configuration incorporating at least a first articulation.

12. An arrangeable system for holding at least one husbandry suitable enclosure according to claim 1, wherein the first extent generally ranges in a first direction, and one or more of the second junction and the first junction mate supply a support capacity in at least a second direction, said first and at least a second directions delineating a first angle.

13. An arrangeable system for holding at least one husbandry suitable enclosure according to claim 12, wherein the first angle has a range of first angle variants that can range from 80 to 100 degrees, including a first angle first variant generally equaling 90 degrees and a first angle second variant generally equaling 92 degrees.

14. A method of arrangeably holding at least one husbandry suitable enclosure comprising the steps of:
assembling a multiply dispositionable first coupling by combining a first junction and a first junction mate,
said first junction and a first anchoring affixment incorporated into a base,
said first junction mate, a second junction, and a first extent separating the first junction mate and the second junction incorporated into an arrangeable member;
assembling a multiply dispositionable second coupling by combining the second junction and a second junction mate,
said second junction mate and an undersurface adapted for disposition upon a structure without affect by the second junction mate incorporated into an enclosure holder; and
arranging the enclosure holder in at least one of first and second/arrangements,
said first/arrangement entailing the first and second couplings being assembled, and
said second/arrangement entailing at least the second coupling being unassembled.

15. A method of arrangeably holding at least one husbandry suitable enclosure according to claim 14, further comprising the step of adapting the enclosure holder for holding at least a first enclosure suitable for husbandry purposes, wherein said adapting for holding comprises at least one of:
a) the enclosure holder and the husbandry suitable enclosure being mutually integrated, and
b) the enclosure holder and the husbandry suitable enclosure being readily detachable.

16. A method of arrangeably holding at least one husbandry suitable enclosure according to claim 15, further comprising the step of exhibiting imagery with at least a first display slot incorporated into at least one of the enclosure holder and husbandry suitable enclosure, said imagery exhibiting optionally involving a releasably displaying first display slot able to display a plurality of imagery.

17. A method of arrangeably holding at least one husbandry suitable enclosure according to claim 14, wherein the assembling of at least one of the first and second couplings allows relative motion between the junction and the junction mate that comprise that coupling and, optionally, at least one of the at least one relative motion allowing coupling can constrain said relative motion.

18. A method of arrangeably holding at least one husbandry suitable enclosure according to claim 14, wherein the assembling of at least one of the first and second couplings can involve a varied plurality of at least one of the combined junctions or junction mates, said junction or junction mate plurality varied according to at least one of their size, orientation, disposition, and construction.

19. A method of arrangeably holding at least one husbandry suitable enclosure according to claim 14, wherein said base can incorporate a plurality of first junctions with, optionally, at least one of the plurality of first junctions being detachable, such that the assembling of the first coupling involves selecting from the plurality of first junctions for combining with the first junction mate.

20. A method of arrangeably holding at least one husbandry suitable enclosure according to claim 14, wherein the arrangeable member can assume at least one of a plurality of configurations that include a first configuration incorporating a variable first extent and a second configuration incorporating at least a first articulation.

21. A method of arrangeably holding at least one husbandry suitable enclosure according to claim 14, wherein the first extent generally ranges in a first direction, and one or more of the second junction and the first junction mate supply a support capacity in at least a second direction, said first and at least a second directions delineating a first angle.

22. A method of arrangeably holding at least one husbandry suitable enclosure according to claim 21, wherein the first angle has a range of first angle variants that can range from 80 to 100 degrees, including a first angle first variant generally equaling 90 degrees and a first angle second variant generally equaling 92 degrees.

23. A system for arrangeably dispositioning a husbandry suitable enclosure comprising:
an anchoring base featuring an attachment plate and a first female junction;
an arrangeably dispositionable arm featuring a first male junction mate and a second male junction separated by a first length of the arrangeably disposable arm;
a detachable husbandry suitable enclosure featuring a second female junction mate incorporated into a husbandry suitable enclosure undersurface, said undersurface adapted for level bearing upon a structure without affect from the second female junction mate when detached;
a first coupling assemblable from the first female junction and the first male junction mate, a second coupling assemblable from the second male junction and the second female junction mate, at least one of said first and second couplings being multiply dispositionable;
wherein the husbandry suitable enclosure is arrangeable in at least first and second configurations, said first configuration entailing the first and second couplings being assembled, and said second configuration entailing at least the second coupling being unassembled to detach the husbandry suitable enclosure.

24. A system for arrangeably dispositioning a husbandry suitable enclosure according to claim 24, wherein the husbandry suitable enclosure incorporates at least a first display slot adapted for exhibiting imagery and, optionally, said first display slot exhibits imagery releasably such that a plurality of imagery is displayable.
